(19) United States
(12) Patent Application Publication
(10) Pub. No.: US 2008/0259713 A1
(43) Pub. Date: Oct. 23, 2008

(54) METHOD FOR EXTENDING THE DELIVERY TIME OF A CEMENTITIOUS SLURRY

(76) Inventor: Russell H. Graeber, Flower Mound, TX (US)

Correspondence Address: CARSTENS & CAHOON, LLP, P O BOX 802334, DALLAS, TX, 75380, US

(21) Appl. No.: 12/107,590

(22) Filed: Apr. 22, 2008

Related U.S. Application Data
(62) Division of application No. 11/112,355, filed on Apr. 22, 2005, now abandoned.

(51) Int. Cl. B01F 15/02; B28C 5/06

(52) U.S. Cl. 366/3

(57) ABSTRACT

System for transporting a load of cementitious slurry, which greatly extends the delivery time in which cementitious slurry may be delivered to a remote work site. The system comprises a trailer mounted tank having a pumping mechanism incorporated therein which continually circulates the cementitious slurry from one end of the tank to an opposing end during transport to the remote work site. The system extracts slurry from one end of the tank and reintroduces it at an opposing end of the tank. The pumping mechanism induces a turbulent flow in the slurry, which continually agitates the slurry, thereby preventing the settling of particles within the slurry. The system allows cementitious slurry to be commercially delivered at reasonable distances without significant fallout or degradation to the consistency of the slurry, and without impairment to the distribution equipment's ability to disperse the cementitious slurry at the remote work site.

### CROSS-REFERENCES TO RELATED APPLICATIONS

This application is a divisional application of co-pending U.S. patent application Ser. No. 11/112,355, filed on Apr. 22, 2005.

### BACKGROUND OF THE INVENTION

1. Technical Field of the Invention

The present invention relates to an apparatus and method of transporting a load of cementitious slurry, especially for road and similar construction work. More particularly, the present invention discloses an apparatus and method that is capable of extending the suspension time of solids in the slurry thereby greatly extending the delivery time in which the cementitious slurry may be delivered to a work site.

2. Description of the Related Art

The use of cementitious slurries is well known and long practiced in the petroleum drilling industry and in the construction industry. For example in the petroleum drilling industry, cementitious slurries are often utilized to cement pipes or casings within a well bore of a subterranean formation for the construction of oil, gas and water wells, and to seal off undesirable formation fluids.

In the construction industry, cementitious binders are particularly useful in stabilizing soil during road construction. Some types of roadbed material, such as clay, require stabilization to eliminate the plasticity of the material. Sandy types of roadbed foundation material require both binding and/or filler to fill air voids between particles of the road base material. Many types of binder material, such as cement, sand, lime, bentonite, and the like may be utilized.

It has previously been the practice to move substantial amounts of road base material, for example, a four foot layer, haul it away, and replace it with four feet of new filler material with dry binder and/or filler already mixed in. The replacement layer then is wet down and packed as necessary to achieve the needed density. The cementitious action between the binder and replacement material provides the needed stable road bed.

More recently, a number of techniques using cementitious slurries have also been developed in the construction industry to prepare road beds for subsequent topping with concrete or asphalt. For example, U.S. Pat. Nos. 5,064,292 and 5,407,299 issued to John S. Sutton each disclose a technique commonly known as “Cement Treated Base” or CTB preparation, wherein a cementitious slurry is applied to a prepared road base. The initial step of a typical CTB preparation includes preparing a road base to a specified depth and grade. The road base may be comprised of in-place native soil, subsoil, natural aggregate such as gravel, processed aggregate such as washed sand, and waste, plus any haul-in aggregates and/or reclaimed material such as reground asphalt road bed. The cementitious slurry is thereupon admixed with the road base and the resulting soil-cement mixture is compacted to a proper height and density. The road base may then be graded and leveled as desired. The resulting road base is then kept damp until covered with a cure coat of asphalt or other material.

Cementitious slurries are typically comprised of a cementitious material, such as a hydraulic cement composition, suspended in an aqueous solution. Such compositions may include fine or course granular aggregates to adjust the viscosity of the slurry for a particular application. Cementitious slurries may also include retardants to slow the process commonly known as chemical hydration. The chemical hydration of cementitious material is a conversion process whereby liquid water combines with the cement particles to form crystalline water. Hydraulic cement compositions, such as Portland cement, derive most of their strength producing properties from chemical hydration. Hydraulic cement typically hydrates in less than 15 minutes. Retardants inhibit the process of chemical hydration, thereby extending the time in which the cementitious material sets up. A number of patents have been issued relating to the art of retardation of chemical hydration. Examples of such chemical hydration retardant processes are disclosed in U.S. Pat. No. 5,244,498 to Steinke, U.S. Pat. No. 5,221,343 to Grauer, et al., U.S. Pat. No. 4,210,456 to Miller, and U.S. Pat. No. 3,053,673 to Walker.

While retardants are useful in slowing the process of chemical hydration, they have limited or no effect on another problem commonly encountered in the delivery and use of cementitious slurries; namely, the limited suspension time of cementitious materials in slurries. Left to their own devices, cementitious materials suspended in slurries begin to flocculate and agglomerate soon after being loaded into a storage tank on a delivery vehicle. While prior art storage tanks fitted with mechanical paddle agitation devices (such as those shown in U.S. Pat. No. 5,496,111 to La Verne) can lessen the inherent settling effects, cementitious slurries typically require distribution within approximately 30 minutes from the time the slurry is loaded and agitation begins.

Conventional concrete mixer trucks have also been used in the prior art to deliver cementitious slurry. However, a load of cementitious slurry traveling in a conventional concrete mixer truck typically sets up and hardens in approximately one-hour and forty-five minutes. Thus, unless the cement batch plant is co-located at the job site, there is not enough time to both deliver and discharge the slurry at the job site and spread it over the surface prior to it setting up. While ligno poly sachride based retardants have been used in the prior art to extend the delivery time of cementitious slurries in rotating drum-type mixer trucks, such slurries are prone to the phenomena of self induced hydration. This phenomena is initiated by nodules of dry or partially wetted cement within the cementitious slurry, which develop into sites of accelerated chemical hydration causing the surrounding volume of cement to experience a significant rise in temperature, which subsequently accelerates chemical hydration in more of the surrounding cement slurry, further increasing the slurry's temperature, and continuing to repeat until the slurry's initial set is reached. The process can be culminated in as little as thirty minutes after the first noticeable viscosity increase. Within an additional thirty minutes, the temperature of the set slurry can exceed 212° F. The results of this phenomena are catastrophic to the owner of the cement mixing truck, either in terms of labor costs to reclaim the mixing drum, or the loss of an irreparable mixing drum.

As a consequence of and in response to the foregoing problematic aspects inherent in delivering cementitious slurries to distant work sites, a number of prior art methods have been developed. For example, U.S. Pat. No. 5,064,292 issued to John S. Sutton discloses a cement mixer truck having a rotating mixer drum which features multiple, mobile heavy objects (e.g., metal balls) which are free to randomly tumble within the rotating slurry, thereby crushing the dry nodules of cement and thoroughly mixing the cement slurry while the slurry is being transported. The Sutton '292 device further includes a retainer mechanism so that the heavy objects (e.g., metal balls) remain in the mixer drum at all times. While generally an improvement over prior art methods directed at transporting cement slurries to remote work sites, the Sutton '292 system had its shortcomings, some of which are noted in a related improvement patent subsequently issued to the same inventor.

For example, as noted in U.S. Pat. No. 5,407,299 issued to Sutton, while the Sutton '292 system produced a slurry ideally suited for CTB construction, the mixing trucks used were excessively heavy with poor maneuverability for spreading the slurry. Moreover, the mix rate per unit was too slow for many large scale CTB operations requiring several units to keep pace. Consequently, the Sutton '299 patent disclosed an on-site dust-free mixing system capable of mixing cementitious slurry suitable for CTB construction at rates exceeding 100 tons of cement per hour. The single on-site mixing unit enables the use of smaller, lighter and more maneuverable spreader trucks and for alternate spread methods which eliminates much of the slurry transportation time and facilitates on-site adjustment and control of slurry properties and slurry production.

Taken together, the Sutton '292 and '299 patents plainly illustrate the dichotomy of problematic aspects inherent with prior art solutions for delivering cementitious slurries to a remote work site. On one hand, conventional mixer trucks may be adapted in the manner of the Sutton '292 patent to prolong the suspension time of cementitious slurries and thereby extend the delivery time and distance to remote work sites. However, such conventional mixer trucks are inherently expensive and inefficient to operate upon remote work sites. On the other hand, while on-site mixing units in the manner of the Sutton '299 patent provide a more flexible system in delivering and dispersing cementitious slurries to the work site, they are also inefficient in that each work site requires its separate mixing unit. Indeed, each work site must allocate a separate area onto which the mixing unit may be positioned. Moreover, the delivery means (e.g., tanker trucks) require immediate project access. Thus, economies of scale in the preparation and delivery of the cementitious slurry can never be realized using individual on-site mixing units disclosed in the Sutton '299 patent.

A need, therefore, exists for a more efficient and inexpensive apparatus, and method for using the same, to deliver cementitious slurries to remote work sites, which is operable in prolonging the suspension time of cementitious materials in slurries. By extending the suspension time of cementitious slurries, the delivery time and distance to remote worksites can likewise be extended. Consequently, a single, large-scale batch mixing plant can be utilized to service a multitude of remote work sites. Thus, economies of scale may be realized enhancing the cost efficiency of operations and customer convenience, both of which are factors which have previously inhibited a more widespread use of cementitious slurries.

### SUMMARY OF THE INVENTION

The present invention provides an apparatus and method for extending the suspension time of cementitious slurry thereby greatly extending the delivery time in which cementitious slurry may be delivered to a remote work site. The apparatus and method of the present invention allows cementitious slurry to be commercially delivered at reasonable distances without significant fallout or degradation to the consistency of the slurry, and without impairment to the distribution equipment's ability to disperse the cementitious slurry at the remote work site.

In one aspect of the invention, the apparatus comprises a tanker truck having a recirculation pump incorporated therein which continually circulates the cementitious slurry during transport to the remote work site. The tanker truck comprises a trailer mounted tank having a discharge port and an intake port on opposing ends. The discharge port is fluidly attached to a manifold having multiple valves for directing the cementitious slurry. The manifold comprises an inlet port, a recirculation port, and an outlet port. Each manifold port further includes a control valve which may be selectively opened or closed as desired. The manifold inlet port is fluidly connected to the discharge port of the trailer mounted tank. The manifold outlet port is fluidly connected to a conduit for dispensing the cementitious slurry. The recirculation port is positioned between the inlet and outlet ports, and fluidly connected to a pumping mechanism, which, in turn, is fluidly connected to the intake port of the trailer mounted tank. Thus, when the respective control valves are properly configured, the cementitious slurry is continuously circulated though the tank during transport to the remote work site. The slurry flows through the discharge port located at one end of the tank and into the manifold where it is redirected though the recirculation port which is fluidly connected to the pumping mechanism, which pumps the slurry back to the intake port located on an opposing end of the tank.

In accordance with one feature of the present invention, as slurry flows through the pumping mechanism, the pumping action of the mechanism shears the cementitious material particles apart preventing flocculation and/or agglomeration of the cementitious material. Moreover, when recirculated back into the tank through the intake port, the slurry flow further agitates the slurry remaining in the tank. The intake port is dimensioned so that the slurry flow induces large scale eddies in the slurry creating a turbulent flow within slurry mass contained within the tank, which assures complete mixing and prevents non-turbulent or dead zones of flow within the mass of slurry within the tank. By continually circulating the entire contents of the tank during transport to a remote work site, the cementitious materials remain suspended in the slurry thereby extending the delivery time in which the cementitious slurry may be delivered.

Upon reaching the work site, the respective control valves are reconfigured allowing the cementitious slurry to be dispensed as required. The slurry thereupon flows from the tank through the discharge port and into the manifold where it is directed via the manifold outlet port to a dispensing conduit. In this configuration, the slurry typically flows by means of gravity, but it may be pumped, if desired. In one embodiment, the dispensing conduit may comprise a conventional spreader bar mechanism from which the slurry is dispensed onto a prepared road bed. In another embodiment, the dispensing conduit may simply comprise tubular conduit, such as a segment of flexible hose or pipe, for transferring the cementitious slurry to a particular application, such as well injection.

Various other features, objects and advantages of the invention will be made apparent from the following description taken together with the drawings.

### BRIEF DESCRIPTION OF THE DRAWINGS

A more complete understanding of the method and apparatus of the present invention may be had by reference to the following detailed description when taken in conjunction with the accompanying drawings, wherein:

FIG. 1 illustrates the side elevational view of the tanker truck of the present invention;

FIG. 2 illustrates an elevational view of the rear of the tanker truck of the present invention; and

FIG. 3 illustrates an enlarged view of the manifold attached to the discharge port of the trailer mounted tank of the tanker truck of the present invention.

Where used in the various figures of the drawing, the same numerals designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the invention.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

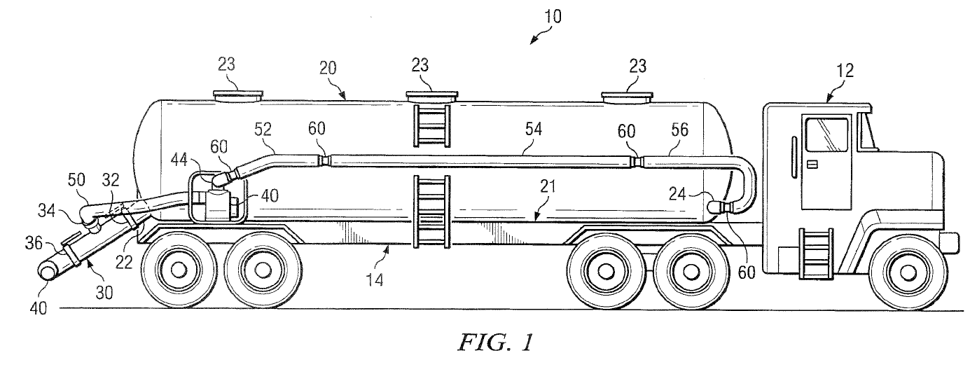

With reference to the drawings, FIG. 1 depicts an overall side view of an embodiment of the tanker truck 10 of the present invention. The tanker truck 10 comprises a trailer mounted tank 20 having a discharge port 22 and an intake port 24 on opposing ends. The tank 20 further includes loading ports 23 through which the cementitious slurry may be initially loaded at a batch facility. The loading ports 23 are typically sealed during transport of the load to a remote site. The viscosity and makeup of the cementitious slurry will vary with the particular application. For example, in one embodiment, the slurry comprises approximately one-third solids (i.e., 33% solids by weight) suspended in two-thirds liquid solution. The slurry may also comprise additives which retard the hydration of the cementitious materials.

While depicted in FIG. 1 as being integral with a motorized towing vehicle 12, it is understood that the trailer 14 upon which the tank 20 is mounted may be a self-contained trailer or carriage that is independent of any motorized transportational means. Moreover, the volumetric size of the tank 20 may be dimensioned so as to be appropriate for a particular application. While a preferred embodiment of the present invention comprises a 5000+ gallon tank mounted on an independent trailer, it is understood that the present invention may be practiced using a larger or smaller sized tank mounted on an independent carriage or on a trailer which is integral with a towing vehicle.

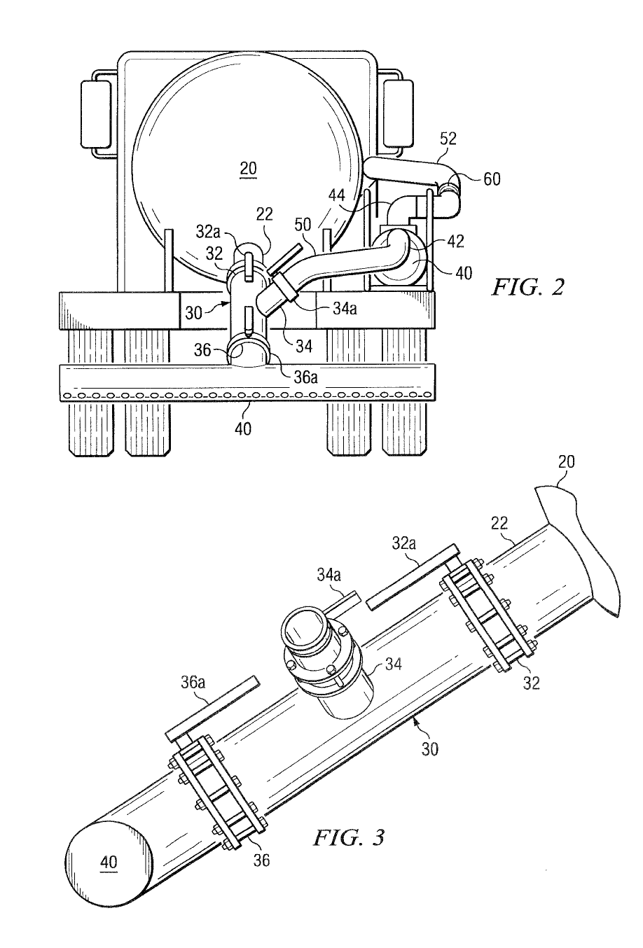

As shown in FIGS. 1 and 2, a multi-port manifold 30 is attached to a tubular exterior portion of the discharge port 22 of tank 20. The manifold 30 comprises an inlet port 32, a recirculation port 34, and an outlet port 36. Each manifold port 32, 34, 36 further includes a respective control valve 32a, 34a, 36a which may be selectively opened or closed as desired. The manifold inlet port 32 is attached to the discharge port 22 of tank 20, such that when the inlet control valve 32a is opened, the interior of tank 20 is fluidly connected with the interior of the manifold 30. In a similar manner, the manifold outlet port 36 fluidly connects to conduit for dispensing the cementitious slurry.

A recirculation port 34 is positioned between the inlet 32 and outlet ports 36, and is fluidly connected to a pumping mechanism 40, which, in turn, is fluidly connected to the intake port 24 of the trailer mounted tank 20. In one embodiment, the means for fluidly connecting the pumping mechanism with the recirculation port 34 and the intake port 24 comprises tubular segments that are external to the trailer mounted tank 20. The tubular segments may be flexible or rigid. For example, in the embodiment illustrated in FIG. 1, the tubular segments 50, 52, and 56 are comprised of flexible rubberized hose, while the tubular segment 54 is comprised of a generally rigid metal pipe. The diameter of the tubular segments 50, 52, 54, and 56 is generally less than the diameter of the interior chamber of the multi-port manifold 30. For example, in a preferred embodiment of the invention, the diameter of the interior chamber of the multi-port manifold 30 is approximately six inches, while the diameter of the tubular segments is approximately four inches.

An auxiliary control valve may also be installed in the fluid connection between the pump outlet 44 and the intake port 24 to prevent backflow of the cementitious slurry from the tank 20 when the pumping mechanism 40 is not operating. This auxiliary control valve may be either a manually-actuated valve or an automatic check valve. In addition, complementary quick-disconnect couplings 60 may be provided at the ends of each of the tubular segments to maintain the flow rate, as well as aid in the assembly/disassembly necessary for cleaning and maintenance of the system. For example, in one embodiment the couplings 60 comprise conventional camlock coupler fittings.

The pumping mechanism 40 provides the primary means for circulating the cementitious slurry though the system of the present invention. As shown in the embodiment illustrated in the figures, the pumping mechanism 40 comprises a conventional wet/solids pump mounted external to the trailer mounted tank 20. The pumping mechanism 40 may be mechanically, electrically or hydraulically powered. Moreover, the pumping mechanism 40 may comprise a self-contained unit or may be powered by a conventional power take-off system powered by towing vehicle 12. For example, in an embodiment of the present invention shown in the figures, the pumping mechanism 40 comprises a self-priming wet/solids centrifugal pump powered by a self-contained reciprocating engine (e.g., Honda® model WT40X pump).

The pumping mechanism 40 includes an inlet 42, which is fluidly connected to the manifold's recirculation port 34, and an outlet 44, which is fluidly connected to the intake port 24 of the trailer mounted tank 20. Thus, when the system of the present invention is configured with the manifold's inlet port control valve 32a and recirculation port control valve 34a in the open position, and the outlet port control valve 36a in the closed position, the pumping mechanism 40 continually circulates the cementitious slurry from the discharge port 22, generally located at the low end rear of the trailer mounted tank 20, to the intake port 24, generally located at the opposing end (i.e., the front) of the tank 20.

The pumping mechanism 40 must have a pumping capacity sufficient to recirculate the entire contents of the tank 20 within a time period necessary to maintain the suspension of cementitious material within the slurry. For example, in an embodiment of the present invention shown in the figures, the pumping mechanism 40 recirculates the entire contents of a tank 20 having a capacity of approximately 5,000 gallons in approximately ten minutes, which is approximately half the normal settling time of the cement particles within the slurry if no agitation exists.

The continual recirculation of the slurry though the system of the present invention typically maintains the suspension of cementitious material within the slurry by means of two distinct actions. First, as the slurry passes through the pumping mechanism 40, the actual pumping action of the pumping mechanism 40 shears apart the particles of cementitious materials preventing the flocculation or agglomeration of particles. Second, the pumping mechanism 40 induces a high pressure flow in the slurry, producing a high Reynold's number that is in the turbulent region of flow for the slurry within the tubular segments 52, 54, and 56 down stream from the outlet 44 of the pumping mechanism 40. This turbulence further agitates cementitious particles suspended in the slurry, thereby preventing agglomeration and settling of cement solids.

Upon reaching the intake port 24 of the trailer mounted tank 20, the high pressure flow of slurry experiences a rapid expansion upon entering the tank 20, inducing large scale eddies or macro turbulence into the slurry contained within the tank 20, which maintains the flow of slurry contained within the tank 20 within the turbulent region of flow thereby minimizing the formation of non-turbulent or dead zones within the slurry mass contained within the tank 20. Thus, the cementitious slurry remains well mixed throughout the process as it circulates through system of the present invention.

As shown in the figures, the cross-sectional diameter of the tank 20 is much greater than the cross-sectional diameter of the tubular segments 52, 54, and 56 and the intake port 24 of the trailer mounted tank 20. For example, in a preferred embodiment of the present invention shown in the figures, the cross-sectional diameter of the tank 20 is approximately fifty-seven inches while the cross-sectional diameters of the tubular segments 52, 54, and 56 and the intake port 24 are approximately four inches. In addition, the intake port 24 is positioned so as to generally induce turbulence within the slurry contained within the tank 20. Typically, a full load of cementitious slurry comprises approximately 85-95% of the volume of the tank 20. Thus, in order to maximize the amount of turbulence generated within the slurry, the intake port 24 is generally positioned towards the bottom 21 of the trailer mounted tank 20, as opposed to being positioned so as to discharge the slurry flow in a free space above the slurry within the tank 20. For example, in a preferred embodiment of the present invention shown in the figures, the intake port 24 is positioned approximately eight inches off the bottom 21 of the trailer mounted tank 20.

In a test of an embodiment of the present invention shown in the figures, the Reynold's number of the slurry flow in the tubular segments 52, 54, and 56 was calculated to be above 8.5×10⁵, while the Reynold's number of the slurry flow within the tank 20 was calculated to be 5.4×10⁴, both in excess of 2,000, the lower critical range for laminar flow. In the test, an aqueous slurry comprised of 34% cementitious solids (e.g., Type I cement) was used. The diameter of the tubular segments 52, 54, and 56 was approximately 4-inches and the tank 20 had a volume of approximately 5,000 gallons. By maintaining sufficient turbulent flow throughout the recirculation process, the system of the present invention prevents the settling of cementitious particles within the slurry while enroute to the remote work site, thus allowing the slurry to be delivered at greater distances without significant fallout or degradation that impairs the distribution equipment's ability to disperse the cementitious slurry at the work site.

Upon reaching the work site, the respective control valves are reconfigured allowing the cementitious slurry to be dispensed as required. For example, upon reaching the remote work site, the pumping mechanism 40 is typically turned off and the recirculation port control valve 34a is configured in the closed position. The manifold outlet port control valve 36a is then opened allowing the load of cementitious slurry contained with the tank 20 to flow through the discharge port 22 and into the manifold 30 where it is directed via the manifold outlet port 36 to a dispensing conduit. In this configuration, the slurry typically flows by means of gravity, but it may be pumped by an accessory pumping means (not shown), if desired. In the embodiment shown in the figures, the dispensing conduit comprises a conventional spreader bar mechanism 40 from which the slurry is dispensed onto a prepared road bed. In another embodiment, the dispensing conduit may simply comprise an accessory tubular conduit, such as a segment of flexible hose or pipe, for transferring the cementitious slurry to a particular application, such as well injection.

It will now be evident to those skilled in the art that there has been described herein an improved apparatus and method for extending the suspension time of solids in a cementitious slurry thereby greatly extending the delivery time in which the cementitious slurry may be delivered to a remote work site.

Although the invention hereof has been described by way of a preferred embodiment, it will be evident that other adaptations and modifications can be employed without departing from the spirit and scope thereof. For example, the pumping mechanism and tubular segments may be fully or partially internalized within the tank. The terms and expressions employed herein have been used as terms of description and not of limitation; and thus, there is no intent of excluding equivalents, but on the contrary it is intended to cover any and all equivalents that may be employed without departing from the spirit and scope of the invention.

1-12. (canceled)

13. A method for prolonging the suspension time of cementitious slurry during transport to a remote work site, comprising:
a) filling a tank mounted upon a trailer with a load of cementitious slurry, said tank having a discharge port and an intake port on opposing ends;
b) fluidly connecting said discharge port to said intake port by means of a fluid connection that is external to said tank, wherein said fluid connection comprises a pumping mechanism; and
c) inducing a turbulent circulatory flow by pumping said slurry from said discharge port to said intake port.

14. The method of claim 13 wherein circulatory flow has a Reynold's number in a turbulent region for said slurry.

15. The method of claim 14 wherein said turbulent region has a Reynold's number greater than 2,000.

16. The method of claim 13 wherein said load of cementitious slurry circulates through said tank in approximately half the normal settling time of the cement particles within the slurry.
